(19) United States
(12) Patent Application Publication
(10) Pub. No.: US 2010/0050005 A1
(43) Pub. Date: Feb. 25, 2010

(54) Display Device and Display Method

(75) Inventor: Masanori Fujiwara, Gyoda-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/360,736

(22) Filed: Jan. 27, 2009

(30) Foreign Application Priority Data
Aug. 19, 2008 (JP) 2008-211048

(51) Int. Cl. G06F 1/32; G06F 1/28; G09G 5/00

(52) U.S. Cl. 713/320; 713/300; 345/211

(57) ABSTRACT

A display device includes: a display module; a storage module storing state setting information indicating whether setting of a power consumption state of the display module has been completed; an information readout module reading out the state setting information from the storage module at startup of the display module; a decision module deciding to set the power consumption state of the display module when the readout state setting information indicates non-setting; a display instruction module causing the display module to display a screen for setting the power consumption state in response to the decision to set the power consumption state; an input module inputting information for setting the power consumption state based on the screen displayed in the display module; and a state setting module setting the power consumption state based on the information inputted by the input module.

### CROSS-REFERENCE TO RELATED APPLICATIONS

This application is based upon and claims the benefit of priority from the prior Japanese Patent Application No. 2008-211048, filed on Aug. 19, 2008; the entire contents of which are incorporated herein by reference.

### BACKGROUND OF THE INVENTION

1. Field of the Invention

The present invention relates to a display device and a display method.

2. Description of the Related Art

Conventionally, a technique of detecting the brightness of a room by a sensor, adjusts the luminance of the display device, and suppresses its power consumption is disclosed (see, for example, JP-B 3816667)

Incidentally, lineup of various products is set for a display device displaying an image and so on in view of function and price to address needs of more consumers (users). In order to respond to the requests from the consumers wanting products at low prices, it is important to suppress the cost by providing no sensor and the like.

### BRIEF SUMMARY OF THE INVENTION

In the case of a display device including no sensor and the like, the consumer has continuously used the device without knowing the display device in a state of consuming much power.

Hence, an object of the present invention is to provide a display device and a display method capable of urging use of the display device in a power-saving state

A display device according to an aspect of the present invention includes: a display module configured to display an image; a storage module configured to store a state setting information indicating whether setting of a power consumption state of the display module has been completed or not; an information readout module configured to read out the state setting information from the storage module at startup of the display module; a decision module configured to decide to set the power consumption state of the display module when the readout state setting information indicates non-setting; a display instruction module configured to cause the display module to display a screen for setting the power consumption state of the display module in response to that the decision module has decided to set the power consumption state of the display module; an input module configured to input information for setting the power consumption state of the display module based on the screen displayed in the display module; and a state setting module configured to set the power consumption state of the display module based on the information inputted by the input module.

A display method according to an aspect of the present invention is a display method in a display device including a display module which displays an image, the method including: reading out an state setting information indicating whether setting of a power consumption state of the display module has been completed or not from a storage module at startup of the display module; deciding to set the power consumption state of the display module when the readout state setting information indicates non-setting; causing the display module to display a screen for setting the power consumption state of the display module in response to the decision to set the power consumption state of the display module; inputting information for setting the power consumption state of the display module based on the displayed screen; and setting the power consumption state of the display module based on the inputted information.

### BRIEF DESCRIPTION OF THE DRAWINGS

FIG. 1 is a block showing a configuration of a liquid crystal display device 1 according to a first embodiment.

FIG. 2 is a conceptual chart showing a table T1 to be stored in a memory module 62 included in the liquid crystal display device 1.

FIG. 3 is a conceptual view showing a power-saving setting menu M1 displayed on a liquid crystal panel 21.

FIG. 4 is a flowchart showing the operation of the liquid crystal display device 1.

FIG. 5 is a conceptual chart showing a table T2 stored in the memory module 62.

FIG. 6 is a conceptual view showing a power-saving setting menu M2 displayed on the liquid crystal panel 21.

### DETAILED DESCRIPTION OF THE INVENTION

### First Embodiment

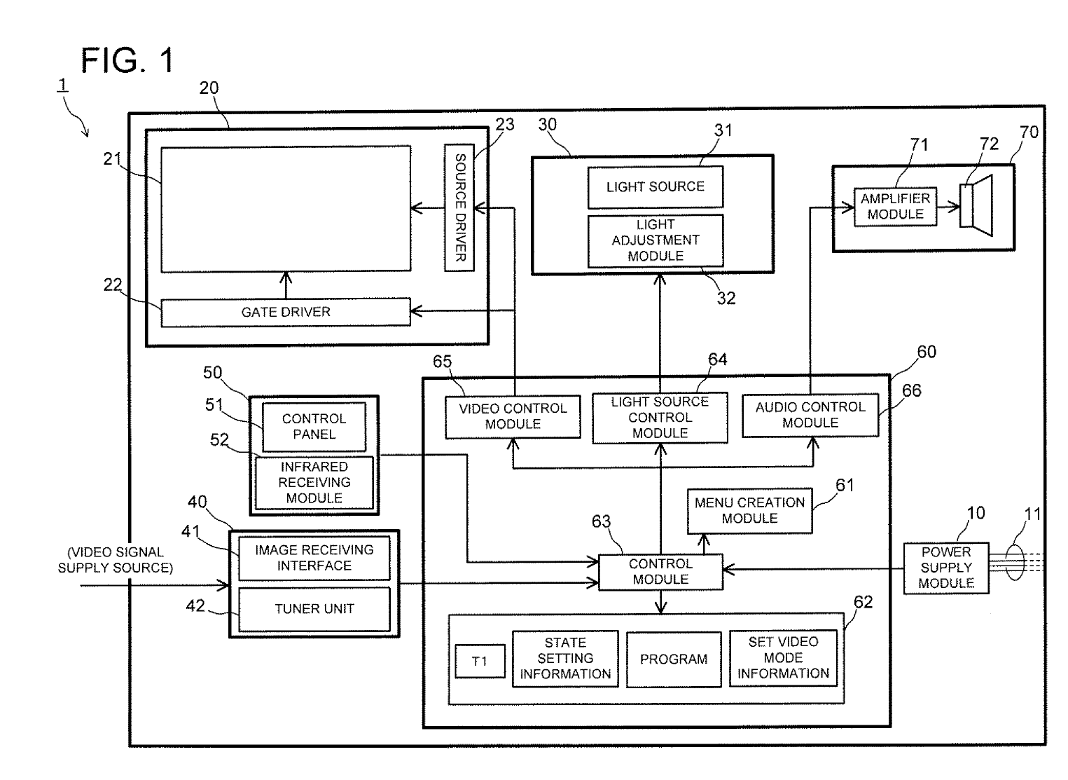

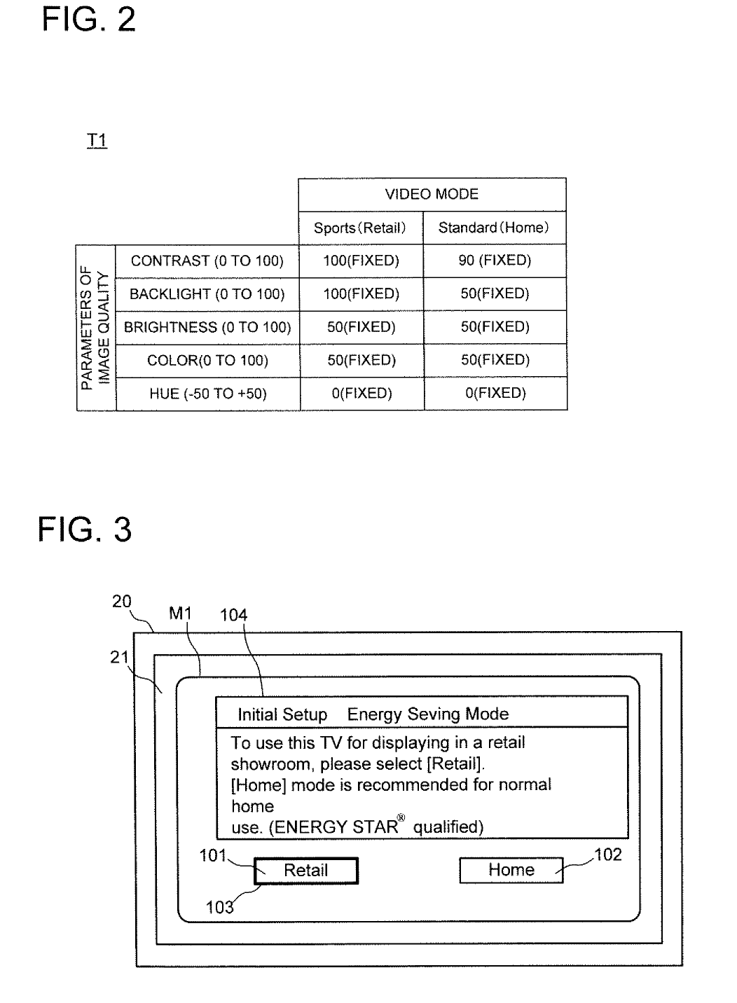

Hereinafter, a liquid crystal display device 1 according to a first embodiment of the present invention will be described in detail with reference to the drawings. FIG. 1 is a block diagram showing a configuration of the liquid crystal display device 1. FIG. 2 is a conceptual chart showing a table T1 to be stored in a memory module 62 included in the liquid crystal display device 1.

The liquid crystal display device 1 includes a power supply module 10, a display module 20, a light source unit 30, a video signal receiving module 40, an input module 50, a video control module 60, and an audio reproduction module 70.

The power supply module 10 includes a power supply line 11 via which power is supplied to the parts in the liquid crystal display device 1. The power supply line 11 is connected to a not-shown commercial power supply.

The display module 20 is mainly composed of a liquid crystal panel 21, a gate driver 22, and a source driver 23.

The liquid crystal panel 21 is constituted to have a liquid crystal material sandwiched between two sheets of glass, though not shown in particular, on which scan lines and data lines are arranged, respectively. The scan lines and data lines intersect to each other and are driven by the gate driver 22 and the source driver 23. Locations where the scan lines and the data lines intersect correspond to pixels. Application of a voltage to the scans line and the data lines causes the pixels to emit colors R, G and B respectively to thereby display a color image on the liquid crystal panel 21. Controlling the magnitude of the voltage applied to the scan lines and the data lines can control the color tone and the like of R, G and B in each of the pixels.

The gate driver 22 sequentially outputs a voltage waveform in a pulse form to the scan lines. The source driver 23 outputs a voltage waveform in a pulse form to the signal lines in response to the output of the voltage waveform in a pulse form from the gate driver 22.

The light source unit 30 has a light source 31 and a light adjustment module 32, and supplies light to the display module 20. The light source unit 30 is disposed behind the display module 20, in particular, the later-described liquid crystal panel 21. Between the light source unit 30 and the liquid crystal panel 21, a pair of diffuser plates and a prism sheet sandwiched between the diffuser plates are provided though not shown. The diffuser plates scatter and diffuse the light from the light source unit 30 to prevent occurrence of unevenness in brightness of the light supplied to the display module 20. The prism sheet is for improving the luminance of the light supplied from the light source unit 30.

One example of the light source 31 is a plurality of cold cathode fluorescent lamps (CCFL) which are fluorescent tubes having a long product life and a low power consumption. Other examples of the light source 31 include light emitting elements such as a light emitting diode (LED), an organic electro luminescence (EL), an inorganic EL, a laser diode.

The light adjustment module 32 is controlled by the video control module 60, to adjust the light of the light source 31. For example, when the light source 31 is a cold cathode fluorescent lamp, the light adjustment module 32 individually control turning on and turning off of the plurality of cold cathode fluorescent lamps. Further, the light adjustment module 32 can supply a voltage or a current in a pulse form to the cold cathode fluorescent lamp to periodically turn on or turn off the illumination by the cold cathode fluorescent lamp, and to adjust the light while controlling the allocation of the turn-on period and the turn-off period of the cold cathode fluorescent lamp. By changing the duty ratio of the pulse waveform, the allocation of the turn-on period and the turn-off period is changed. For example, the light adjustment module 32 adjusts the brightness of the cold cathode fluorescent lamp to maximum by continuously turning on the cold cathode fluorescent lamp. The light adjustment module 32 adjusts the cold cathode fluorescent lamp to a medium brightness by setting the duty ratio of the pulse waveform relatively large, and adjusts the cold cathode fluorescent lamp to a lower brightness by setting the duty ratio relatively small.

For example, when the light source 31 is a light emitting element such as an LED or the like, the light adjustment module 32 adjusts the voltage to be applied to the light emitting element to directly vary the luminance of the light emitting element.

The adjustment by the light adjustment module 32 increases or decreases the power consumption of the entire light source unit 30. The power consumption increases when the light is adjusted to increase the luminance of the light to be supplied to the display module 20. Conversely, the power consumption decreases when the light is adjusted to decrease the luminance of the light to be supplied to the display module 20. Note that the image to be displayed on the liquid crystal panel 21 becomes brighter with an increase in luminance of the light supplied to the display module 20.

The video signal receiving module 40 receives various video signals (signals containing image data and audio data) from the outside of the liquid crystal display device 1 and outputs the received video signals to the video control module 60.

“Image data” contained in the video signal is composed of pixel data for R, G, and B. The pixel data for R, G, and B correspond to the pixels of the liquid crystal panel 21, respectively. The image data has a luminance value as information indicating the brightness of each of the pixels.

The video signal receiving module 40 includes an image receiving interface 41 and a tuner unit 42.

The image receiving interface 41 includes an HDMI (High-Definition Multimedia Interface) terminal, a component terminal, a composite terminal and so on, and to which the liquid crystal display device 1 and the external connection device (for example, a DVD player, a DVD recorder, a PC) and so on are connected.

The tuner unit 42 is connected a not-shown antenna or the like to receive various video signals on a terrestrial analog wave, a terrestrial digital wave, a wave for satellite broadcasting and so on.

The input module 50 is operated by a user to output, to the video control module 60, information indicating On/Off of the power supply of the liquid crystal display device 1 and information for selecting a button displayed as an image on the liquid crystal panel 21.

The input module 50 includes a control panel 51 and an infrared receiving module 52. The control panel 51 is, for example, a touch panel, a press-type button group, a keyboard or the like. The infrared receiving module 52 receives a command from a not-shown remote controller on which buttons conforming to the control panel 51 are mounted.

The video control module 60 controls the display module 20, the light source unit 30, the audio reproduction module 70 and so on. Concretely, the video control module 60 causes the display module 20 to display an image. The light source unit 30 varies the luminance of the light to be supplied to the display module 20. The video control module 60 causes the display module 20 to display a power-saving setting menu M1 for varying the luminance of the light to be supplied to the display module 20. The video control module 60 causes the audio reproduction module 70 to emit audio.

The video control module 60 includes a menu creation module 61, a memory module 62, a control module 63, a light source control module 64, a video control module 65 and an audio control module 66.

The menu creation module 61 creates the power-saving setting menu M1. The “power-saving setting menu M1” is for the user to adjust the hue and the tone of the image to be displayed in the display module 20 and the luminance of the light to be supplied to the display module 20 by the light source unit 30 in accordance with the use environment of the liquid crystal display device 1.

In the memory module 62, program, table T1, state setting information, set video mode information and so on are stored.

The “program” is information to be read into the control module 63 at the system startup of the liquid crystal display device 1. In the program, control information for the entire liquid crystal display device 1 is described.

In the “table 1,” a video mode and parameters of image quality including contrast, backlight, brightness, color, and hue which are set for each video mode are shown corresponding to each other (see FIG. 2).

The “video mode” is classified into two modes of “Sports” and “Standard.” The parameters of image quality are previously allocated to each of these classifications. The “Sports” mode is optimized for display at appliance dealers and the like, and is to supply the light with the highest luminance to the display module 20. In the “Sports” mode, the light source 31 is turned on while consuming the highest power. The “Standard” mode is optimized, for example, for use in a typical house and is to supply the light with a luminance lower than that of the “Sports” mode to the display module 20. The light source 31 is turned on while consuming the power consumption lower in the “Standard” mode than in the “Sports” mode.

The parameters of image quality define the hue and the tone of the image to be displayed on the liquid crystal panel 21 and the luminance of the light to be supplied from the light source unit 30 to the display module 20.

The larger the parameter corresponding to “contrast” is, the larger the difference between the luminance value for the brightest image and the luminance value for the darkest image becomes, resulting in a sharp image displayed on the liquid crystal panel 21.

The parameter corresponding to “backlight” (1 to 100) indicates the percentage (%) of the luminance of the light to be supplied to the display module 20 to the maximum luminance of the light source unit 30 which can be supplied to the display module 20. In the “Standard” mode, the light with a luminance about half that in the “Sports” mode is supplied to the display module 20.

The larger the parameter corresponding to “brightness” is, the brighter the color of the image to be displayed on the liquid crystal panel 21 becomes.

The larger the parameter corresponding to “color” is, the stronger and thicker the tone (the strength of color and the appearance of shading) of the image displayed on the liquid crystal panel 21 becomes.

The larger the parameter corresponding to “hue” is, the more reddish the tint (color balance) of the image displayed on the liquid crystal panel 21 becomes, whereas the smaller the parameter is, the more bluish the tint becomes.

The “state setting information” indicates whether or not the power consumption state is set.

The “set video mode information” indicates a set video mode when the power consumption state is set.

The control module 63 functions as an information readout module, a decision module, a display instruction module, and a state setting module.

The control module 63 controls the modules such as the light source control module 64. Into the control module 63, the video signal outputted from the video signal receiving module 40 is inputted. The control module 63 takes image data and audio data out from the inputted video data, and outputs the data to the video control module 65 and the audio control module 66, respectively.

The control module 63 controls the light source control module 64 to perform instruction of turning on and light adjustment of the light source 31. The control module 63 is monitoring the presence or absence of supply of power from the power supply module 10. When receiving supply of power from the power supply module 10, the control module 63 refers to the state setting information stored in the memory module 62.

The control module 63 decides whether to execute the setting of the power consumption state of the display module 20 (the setting and change of the video mode) based on the referred state setting information.

When the referred state setting information is non-setting indicating that the power consumption state has not been set yet, the control module 63 causes the menu creation module 61 to create the power-saving setting menu M1. The control module 63 outputs the created power-saving setting menu M1 as image data to the video control module 65.

The control module 63 is monitoring the input from the input module 50 at all times. The control module 63 reads the parameters of image quality corresponding to the video mode selected by the input module 50 based on the power-saving setting menu M1 displayed on the liquid crystal panel 21, and outputs the parameters to the video control module 65 and the light source control module 64. Concretely, the control module 63 outputs the parameter of “backlight” to the light source control module 64, and outputs the parameters other than that of “backlight” to the video control module 65.

The light source control module 64 calculates the luminance of the light to be supplied to the display module 20 based on the parameters of image quality outputted from the control module 63, outputs the luminance to the light adjustment module 32 to control turning-on/off of the light source 31 and the light adjustment. For example, when a parameter (100) of “backlight” in the “Sports” is outputted, the light source control module 64 calculates a luminance value so that the light with the highest luminance is supplied to the display module 20 from the light source unit 30, and outputs the luminance value to the light adjustment module 32. For example, when the light source 31 is turned on using a parameter (50) in the “Standard,” the light with a luminance about half the whole is emitted from the light source unit 30 as a result. In this event, the power consumed in the light source unit 30 is reduced.

The video control module 65 controls the gate driver 22 and the source driver 23 to cause them to display the image corresponding to the image data outputted from the control module 63, on the liquid crystal panel 21.

The video control module 65 has an image memory (not shown) which temporarily stores image data. The image data written into the image memory is displayed as an image on the liquid crystal panel 21.

The video control module 65 controls the gate driver 22 and the source driver 23 to cause them to set the transmittance through the pixels of the liquid crystal panel 21 to realize the luminance value of the pixels constituting the image data outputted from the control module 63.

The video control module 65 changes the luminance value of the pixels constituting the image data by calculation based on the parameters of image quality outputted from the control module 63. The gate driver 22 and the source driver 23 are controlled to realize the changed luminance value, with the result that an image with a higher contrast or a whitish image (with a higher brightness) than that of the image corresponding to the original image data outputted from the control module 63 is displayed on the liquid crystal panel 21.

The audio control module 66 outputs audio taken out of the video signal to the audio reproduction module 70.

The audio reproduction module 70 includes an amplifier module 71 and a speaker 72, and generates audio based on the audio data outputted from the audio control module 66.

Next, the power-saving setting menu M1 displayed on the liquid crystal panel 21 will be described with reference to FIG. 3. FIG. 3 is a conceptual view showing the power-saving setting menu M1 displayed on the liquid crystal panel 21.

The liquid crystal panel 21 includes selection button screens 101 and 102, a pointer 103 (a thick frame on the selection button screen 101), and an explanation window 104, as the power-saving setting menu M1.

In the selection button screens 101 and 102, “Retail” and “Home” are displayed respectively, which are selected by the pointer 103. “Retail” and “Home” are associated with “Sports” and “Standard” in the table T1, respectively.

In the explanation window 104, information for explaining to the user to select which of the selection button screens 101 and 102 is displayed. More specifically, a text is displayed to prompt the user to select “Retail” (the selection button screen 101) for use as a monitor at shops, whereas a text is displayed to recommend the user to select “Home” (the selection button screen 102) for use at home. In this event, when “Home” is selected, a text is also displayed that the liquid crystal display device 1 conforms to ENERGY STAR (registered trademark). Note that ENERGY STAR is a power-saving program for n electric devices promoted by US Environmental Protection Agency (EPA). Though a text in English is displayed here in the explanation window 104, the text is not limited to this but can be displayed in a language corresponding to a nation where the liquid crystal display device 1 is used.

The pointer 103 moves over items in conjunction with the button operation of the input module 50. A viewer can press a not-shown “decision button” of the input module 50 when the pointer 103 overlaps an arbitrary item to thereby select the item.

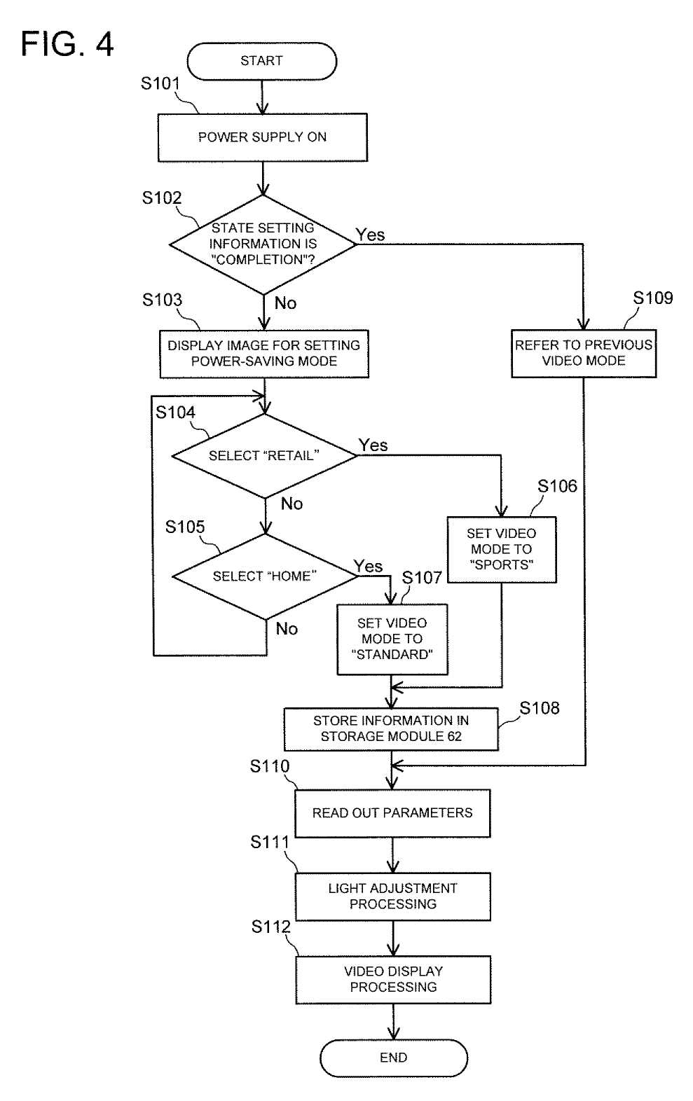

Next, the operation of the liquid crystal display device 1 configured as described above will be described using FIG. 4. FIG. 4 is a flowchart showing the operation of the liquid crystal display device 1.

### (1) Power Supply On (Step S101)

The user presses the power supply button of the input module 50, whereby power is supplied to the modules.

### (2) Check State Setting Information (Step 102)

When receiving supply of power, the control module 63 refers to the memory module 62 and reads the program for processing in Step S102 and thereafter.

The control module 63 then refers to the state setting information stored in the memory module 62 following the read program.

### (3) Set Video Mode (Step S103)

When the state setting information is non-setting in Step S102, the control module 63 causes the menu creation module 61 to create the power-saving setting menu M1. The control module 63 controls the video control module 65 to display the created power-saving setting menu M1 on the display module 20.

### (4) Set Video Mode (Steps S104 to S108)

The control module 63 receives information indicating the button selected by the user from the input module 50 based on the power-saving setting menu M1 displayed in the display module 20 (Steps S104 and S105).

The control module 63 refers to the table T1 in the memory module 62 for a video mode corresponding to the information indicating the button selected by the user contained in the received information, and sets the video mode as a video mode thereafter (Steps S106 and S107.

The control module 63 causes the memory module 62 to store the state setting information indicating “completion” and the set video mode information indicating the set video mode (Step S108).

### (5) Set Previous Video Mode (Step S109)

When the state setting information indicates “completion” in Step S102, the control module 63 refers to the memory module 62 and retrieves the set video mode information.

More specifically, the case where the state setting information indicates “completion” means that the operation mode has been already set, and therefore the control module 63 refers to the set video mode information stored in the memory module 62, and keeps the previously set video mode as the video mode continuously thereafter.

### (6) Read Out Parameters (Step S110)

The control module 63 then refers to the table T1 in the memory module 62, and reads out parameters of image quality corresponding to a newly set or the previously set video mode.

### (7) Light Adjustment Processing (Step S111)

The control module 63 outputs the parameters of image quality corresponding to the backlight read out in Step S110 to the light source control module 64. The light source control module 64 calculates the luminance value of the light to be supplied to the display module 20 based on the received parameters of image quality corresponding to the backlight, and controls the light adjustment module 32 so that the light with the calculated luminance is supplied to the display module 20.

### (8) Video Display Processing (Step S112)

The control module 63 outputs the image data contained in the video signal outputted from the video signal receiving module 40 and the parameters of image quality read out in Step S110 to the video control module 65.

The video control module 65 calculates the luminance value of the image to be displayed on the display panel 21 based on the image data and the parameters of image quality outputted from the control module 63, and generates image data having the calculated luminance value.

The video control module 65 controls the gate driver 22 and the source deriver 23 to cause them to display an image corresponding to the generated image data on the liquid crystal panel 21. In this event, the brightness of the image displayed on the liquid crystal panel 21 is different depending on the brightness of the light source 32 which has been subjected to light adjustment in Step S111.

A conventional liquid crystal display device has often automatically operated in the “Sports” mode when the state setting information is non-setting (for example, when the power is turned on for the first time after factory shipment).

The liquid crystal display device 1 according to this embodiment can urge the user to use the video mode in which the liquid crystal display device 1 operates with reduced power, by displaying the power-saving setting menu M1 when the state setting information is non-setting at the startup of the system, and thereby prevent the liquid crystal display device 1 from being continuously used in a state using much power to reduce the power consumption.

Further, the liquid crystal display device 1 can urge the user to make the setting to create a bright and vivid video for use at shops, whereas can urge the user to make the setting to create a video with an appropriate brightness for use in a typical house.

### Other Embodiments

Though the liquid crystal display device 1 according to one embodiment of the present invention has been described above, the present invention is not limited only to the above-described embodiment, but can be variously modified without departing from the spirit of the present invention. For example, the input module 50 may include a button to clear the state setting information indicating “completion” stored in the memory module 62 (namely, into the state of “non-setting”). In the case where the state setting information indicating “completion” is cleared, when the power supply of the liquid crystal display device 1 is turned on, the power-saving setting menu M1 is displayed on the liquid crystal panel 21, so that the processing of setting the video mode is performed again.

Further, though the video mode is classified into two modes such as the “Sports” mode and the “Standard” mode in the above-described embodiment, the video mode can also be classified into a plurality of modes.

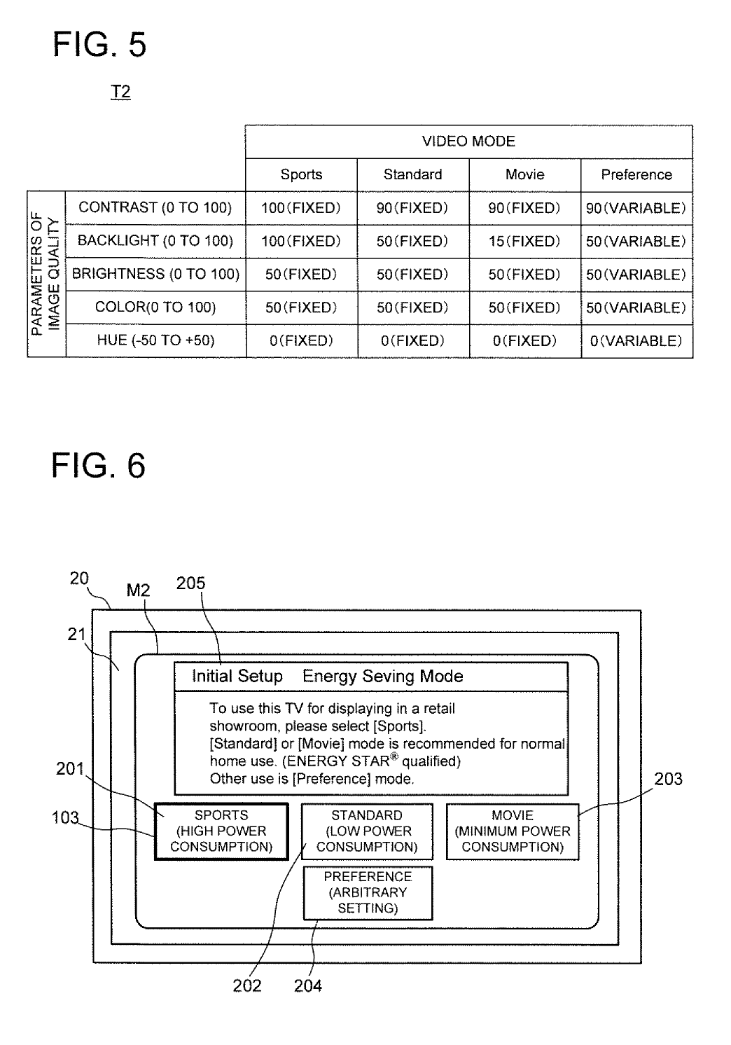

An example in which the video mode is classified into a plurality of modes will be described using FIG. 5. FIG. 5 is a conceptual chart showing a table T2 stored in the memory module 62. Note that in the following description, description of the same portion as in the first embodiment will be omitted.

In the table T2, the video modes are shown associated with parameters of image quality including contrast, backlight, brightness, color, and hue which are set for each of the video modes as in the table T1. The table T2 is stored in the memory module 62 in place of the table T1.

The “video mode” is classified into “Sports,” “Standard,” “Movie,” and “Preference.” The “Sports” and “Standard” are the same as those in the table T1 and therefore description thereof will be omitted.

The “Movie” mode is optimized, for example, for use in a typical house similarly to the “Standard” mode. Further, the “Movie” mode is optimized for viewing movies in which light with a luminance lower than that in the “Standard” mode is supplied to the display module 20. In the “Movie” mode, the light source 31 is turned on with a power consumption lower than that in the “Standard” mode.

As the parameters in the “Preference” mode, values appropriately set by the user using the input module 50 are applied. For example, the user can press a not-shown button for adjusting the video mode of the input module 50 to set the parameters. In this event, the control module 63 stores the set parameters into the table T2 as the setting of the “Preference” mode. Note that as initial values of the parameters of the “Preference” mode, numeric values as those in the “Standard” are applied.

The menu creation module 61 creates a power-saving setting menu M2 corresponding to the modes of “Sports,” “Standard,” “Movie,” and “Preference” in the table T2.

Next, the power-saving setting menu M2 displayed on the liquid crystal panel 21 will be described with reference to FIG. 6. FIG. 6 is a conceptual view showing the power-saving setting menu M2 displayed on the liquid crystal panel 21.

The liquid crystal panel 21 includes selection button screens 201 to 204, a pointer 103 (a thick frame on the selection button screen 201), and an explanation window 205 as the power-saving setting menu M2.

The selection button screens 201 to 204 are displayed as “Sports (high power consumption),” “Standard (low power consumption),” “Movie (minimum power consumption),” and “Preference (arbitrary setting)” respectively, and selected by the pointer 103.

The selection button screens 201 to 204 are associated with “Sports,” “Standard,” “Movie,” and “Preference” in the table T2, respectively.

In the explanation window 205, information for explaining to the user to select which of the selection button screens 201 to 204.

More specifically, a text is displayed to prompt the user to select “Sports” (the selection button screen 201) for use as a monitor at shops, a text is displayed to select “Standard” (the selection button screen 202) or “Movie” (the selection button screen 203) for use in a typical house, where as a text is displayed to recommend the user to select “Preference” (the selection button screen 204) for other cases.

In this event, when “Standard” or “Movie” is selected, a text is also displayed that the liquid crystal display device 1 conforms to ENERGY STAR.

Note that the operation of the liquid crystal display device 1 when the table T2 is stored in the memory module 62 is substantially the same as that in the first embodiment, and therefore the detailed description thereof will be omitted here.

As described above, the power-saving setting menu M2 is displayed on the liquid crystal panel 21, whereby the user can select an arbitrary video mode.

### Other Embodiments

Embodiments of the present invention are not limited to the above-describe embodiments, but can be extended or changed, and the extended and changed embodiments are also included in the technical scope of the present invention.

What is claimed is:

1. A display device comprising:
a display module configured to display an image;
a storage module configured to store a state setting information indicating whether setting of a power consumption state of the display module has been completed or not;
an information readout module configured to read out the state setting information from the storage module at startup of the display module;
a decision module configured to decide to set the power consumption state of the display module when the readout state setting information indicates non-setting;
a display instruction module configured to cause the display module to display a screen for setting the power consumption state of the display module in response to that the decision module has decided to set the power consumption state of the display module;
an input module configured to input information for setting the power consumption state of the display module based on the screen displayed in the display module; and
a state setting module configured to set the power consumption state of the display module based on the information inputted by the input module.

2. The display device according to claim 1, further comprising a storage instruction unit which causes the storage module to store the state setting information indicating that setting of the power consumption state has been completed, in response to that the power consumption of the display module has been set by the state setting module.

3. The display device according to claim 1,
wherein the display module is set to a state to consume a first power or a second power lower than the first power, and
wherein the display instruction module causes the display module to display information indicating that the state to consume the second power conforms to standards relating to power saving, together with the screen for setting the power consumption state of the display module.

4. The display device according to claim 1,
wherein the display module includes a liquid crystal panel on which an image is displayed and a light source which supplies light to the liquid crystal panel, and
wherein the setting of the power consumption state is performed by changing a luminance of the light source.

5. The display device according to claim 1, further comprising a tuner module for receiving a radio wave containing image data to be displayed in the display module.

6. A display method in a display device comprising a display module configured to display an image, the method comprising:
reading out an state setting information indicating whether setting of a power consumption state of the display module has been completed or not from a storage module at startup of the display module;
deciding to set the power consumption state of the display module when the readout state setting information indicates non-setting;
causing the display module to display a screen for setting the power consumption state of the display module in response to the decision to set the power consumption state of the display module;
inputting information for setting the power consumption state of the display module based on the displayed screen; and
setting the power consumption state of the display module based on the inputted information.

7. The display method according to claim 6, further comprising:
causing the storage module to store the state setting information indicating that setting of the power consumption state has been completed, in response to that the power consumption of the display module has been set.

8. The display method according to claim 6,
wherein the display module is set to a state to consume a first power or a second power lower than the first power, and
wherein in the step of causing to display, information indicating that the state to consume the second power conforms to standards relating to power saving is displayed in the display module together with the screen for setting the power consumption state of the display module.

9. The display method according to claim 6,
wherein the display module includes a liquid crystal panel on which an image is displayed and a light source which supplies light to the liquid crystal panel, and
wherein the step of setting includes a step of changing a luminance of the light source.

10. The display method according to claim 6, further comprising receiving a radio wave containing image data to be displayed in the display module.
